(19) United States
(12) Patent Application Publication
(10) Pub. No.: US 2025/0202320 A1
(43) Pub. Date: Jun. 19, 2025

(54) Shielding power generation system consists of coil, control circuit, capacitor and battery

(71) Applicant: LEI HAN, BEIJING (CN)

(72) Inventors: LEI HAN, BEIJING (CN); WANHUI HAN, BEIJING (CN)

(21) Appl. No.: 18/011,492

(22) PCT Filed: May 22, 2021
(86) PCT No.: PCT/CN2021/095353

§ 371 Date: Dec. 19, 2022

(30) Foreign Application Priority Data
Jun. 20, 2020 (CN) 202010569121.3

(51) Int. Cl. H02K 11/01; H02J 7/00; H02J 7/34; H02K 9/19; H02K 11/00; H02K 11/02

(52) U.S. Cl. CPC H02K 11/01; H02J 7/0013; H02J 7/342; H02J 7/345; H02K 9/19; H02K 11/0094; H02K 11/02; H02J 2207/50; H02J 2310/48

(57) ABSTRACT

A shield power generation system consists of coils, control circuits, capacitors and batteries. The first total shield arranged in the shell is connected with an electronic control system, the electronic control system is connected with a super capacitor circuit. The super capacitor circuit is connected with a backup battery, and the backup battery is connected with a main battery. The first total shield is connected with an electronic control system, and is used for generating induced electromotive force through the movement of a motor controller and a motor inside the first total shield relative to the coil winding of the first total shield. The electronic control system filters, rectifies, multiplies and stabilizes the received induced electromotive force from the first total shield, and then obtains a suitable stable voltage, which is input into the super capacitor circuit, and the charge is stored in the super capacitor, which is connected with the backup battery of the electric vehicle and charges the backup battery. This system makes the electromagnetic field intensity of electric vehicle less than 0.2 μt, and achieves the purpose of eliminating the electromagnetic field in shield.

### TECHNOLOGY FIELD

The application relates to a shielded power generation system consisting of a coil, a control circuit, a capacitor and a battery, in particular to making the motor controls the machine and the motor, and the magnetic field lines generated cut the coil, connecting the battery to form a closed circuit, so that the coil generates alternating induced current, which is rectified by a silicon rectifier to be DC and then stored in the capacitor and then stored in the battery. The system makes the electromagnetic field intensity of an electric vehicle less than 0.4 μt, achieves the purpose of eliminating the electromagnetic field in the shielded body, and belongs to the technology field of electromagnetic field shielding and inertial energy storage pulse power supply.

### BACKGROUND TECHNOLOGY

Pulse generator, as an inertial energy storage pulse power supply, is driven by prime mover. Pulse generator integrates inertial energy storage, electromechanical energy conversion and pulse shaping, and has the comprehensive advantages of “single unit”, which are high energy density, high power density, being suitable for repeated discharge, flexible pulse waveform adjustment and so on.

The ratio of the charge Q of the capacitor to the voltage U between the two poles of the capacitor is called the capacitance of the capacitor. In circuit science, given the difference of electric potential between two points in electric field, the capacity of a capacitor to store charge is called capacitance and marked as C. The international system of units is adopted, and the unit of capacitance is farad, marked as F.

Electric vehicle drive motor's electromagnetic field intensity and the safety analysis: The electromagnetic field radiation intensity of electric car's drive motor within 0.6 m is more than 100 μT, causing the driver's body in the high electromagnetic environment for a long time, which is above the medical standards (<0.4 μT) 250 times, which seriously damage the human health. Huang Qingyun, Xie Weidong. New Technology of Electric Vehicle Drive Motor's Electromagnetic Field Intensity Distribution and the Safety Analysis. 2013 (2): 119-120.

The harm of extremely low frequency electromagnetic field radiation to human body

After long contact of the magnetic field (greater than 0.4 μT), the pregnant mothers' children are at increasing risk of getting acute lymphoblastic leukemia. When the bedroom's magnetic field intensity is greater than 0.4 mu T, the OR value of childhood leukemia is 2 (95% CI is 1.27-3.13). When the magnetic field intensity exceeds 0.3 mu T, children leukemia OR value is 1.7 (95% CI is 1.2-2.3). Research Progress of Extremely Low Frequency Electromagnetic Field Radiation and Incidence of childhood leukemia. International journal of pediatrics. 2011 (7): 38-4.3.0.2.

5. Three aspects of electromagnetic pulse protection

5.1. Shielding: Shielding makes use of shielding body to block or reduce the transmission of electromagnetic energy to achieve electromagnetic protection, allowing no electromagnetic field to reach the protected devices.

5.2. Grounding: Grounding is the connection between the electronic devices and the earth through appropriate methods and approaches in order to improve the stability of electronic equipment and effectively restrain the influence of external electromagnetic field, avoiding the interference and damage caused by discharging, which is cause by charge accumulation.

5.3. Filter: A filter can be formed into selective network with resistance, inductance and capacitance to achieve the filtering effect. A filter can also be made of lossy material such ferrite to filter. (Reference: Sun yongjun, Principles and Protection of Electromagnetic Pulse [J], Space Electronic Technology, 2004 (3))

6. The world's most advanced power surge protector (SPD): Signal lines and circuit control protection are the world's leading power purification, precision instrument protection, power surge protection products. The sine wave that can track the filtering and special chemical packaging patent technology includes surge protection and filtering technology, which are in line with the technology requirements of electromagnetic pulse protection. The product (SPD) has the following advantages:

6.1. Because of the multi-level protection mechanism, the residual pressure can reach 0V. The surge voltage after diversion is generally between 2.5 KV˜15 KV. Devices that equipped with SPD can achieve very low residual pressure. (Zero volt can be reached in some special industry) The smaller the residual pressure is, the better the protection effect is.

6.2. Its response speed is less than 1 ns, which can prevent the second lightning, induced lightening and the internal flow of electrical transient voltage suppressor (TVS) effectively.

6.3. The shell adopts NEMA 4 standard, and it is waterproof, fireproof, explosion-proof and anti-static.

6.4. The patented sine wave ORN tracking technology can eliminate surge and harmonic wave accurately.

6.5. The one and only chemical packaging patent technology can ensure the devices' reliable performance in a long time.

6.6. The true 10 mode (full mode) protection can filter waves between lines,
blocking all possible channels of surge include blocking the channel between the lines and the ground to create a perfect protection.

6.7. The capacitor design is hybrid multi-module with both thermal insurance and electric insurance.

6.8. The surge protection product is the only one that is earth-free, using patented sine wave tracking technology,

7. China Patent 201510334961.0 discloses an electromagnetic field shielding system for electric vehicle driving motor. This patent is a failure. The shell is not a closed coil, and the electromagnetic field can only generate voltage on the shell but can't induce current on it. So, the electromagnetic field will directly penetrate the shell.

### Invention Content

The conditions for generating induced current are: a part of the conductor cuts the magnetic induction line in the magnetic field, which is that the moving direction of the conductor in the magnetic field is not parallel to the direction of the magnetic induction line; Second, the circuit is closed. The induced voltage is generated at both ends of the conductor that cuts the magnetic induction line in the magnetic field, which is a power supply. If the circuit is closed, the induced current will be generated in the circuit.

This application applies the above theorem to solve the problem that the existing motor shield can't shield electromagnetic field. The solution is making the motor controls the machine and the motor, and the magnetic field lines generated cut the coil, connecting the battery to form a closed circuit, so that the coil generates alternating induced current, which is rectified by a silicon rectifier to be DC and then stored in the capacitor and then stored in the battery. The system makes the electromagnetic field intensity of an electric vehicle less than 0.4 μt, thus achieving the purpose of eliminating the magnetic field in the shield.

The first driving motor of the electric vehicle is matched with the first gear box. The second driving motor is matched with the second gear box. the backup battery supplies power to the main battery. The main battery supplies power to the electronic devices of the electric vehicle and drives the first driving motor and the second driving motor to push the electric vehicle to move. The motor housing is arranged on the third bracket, and the third bracket is fixed on the electric vehicle by the third screw and the fourth screw. And the motor housing leads the grounding wire from the first total shield or the second total shield inside the motor housing to the electric vehicle body by connecting the third bracket, and the third bracket is made of a conductive metal material.

A first total shield or a second total shield is arranged in the motor housing. And the first general shield or the second general shield of the power generation system consisting of coils, control circuits, capacitors and batteries is connected with the electronic control system. The electronic control system is connected with the super capacitor circuit. The super capacitor circuit is connected with the backup battery. and the backup battery is connected with the main battery.

The first total shield or the second total shield is connected with the electronic control system, and is used for generating the induced electromotive force through the movement of the motor controller and the motor inside the first total shield or the second total shield relative to the coil winding of the first total shield or the second total shield; The electronic control system filters, rectifies, multiplies and stabilizes the received induced electromotive force from the first general shield or the second general shield, and then obtains a suitable stable voltage, which is input into the super capacitor circuit, and the charge is stored in the super capacitor. The super capacitor circuit is connected with and charges the backup battery of the electric vehicle, and the backup battery charges the main battery of the electric vehicle. In the silicon rectifier circuit, the three-phase full-wave rectifier diodes are D1, D2, D3, D4, D5 and D6; the voltage stabilizing circuit includes the filter capacitor WD of C1 and the DC voltage conversion integrated circuit IC1; the super capacitor circuit includes two single capacitors C2 and C3 connected in series; the diode D7 prevents the current of the backup battery 6 from flowing back to the total shielded power generation system; and the IC1 is a wide input voltage DC-DC conversion integrated circuit.

Based on the fast-charging characteristics of supercapacitors C2 and C3, they are used as relay energy storage elements for charging Because the service life of supercapacitor is longer than that of battery, it will not pollute the environment after being scrapped, and it can directly replace battery as energy storage element. Combining the power characteristics of the capacitor with the high energy storage of the battery, the supercapacitor can be charged to any potential within its rated voltage range and completely discharged, while the battery is limited by its own chemical reaction to work in a narrow voltage range, and over-discharge may cause permanent damage. The state of charge (SOC) of supercapacitor and voltage consist of a simple function, while the state of charge of battery includes various complicated conversions. Supercapacitors can store more energy than traditional capacitors with the same volume, and batteries can store more energy than supercapacitors with the same volume. Supercapacitors can be charged quickly, but batteries will be damaged when charged quickly. Supercapacitors can be repeatedly cycled hundreds of thousands of times, while the battery life is only a few hundred cycles.

The application has the beneficial effects that: the shield power generation system consists of coil, control circuit, capacitor and battery making the motor controls the machine and the motor, and the magnetic field lines generated cut the coil, connecting the battery to form a closed circuit, so that the coil generates alternating induced current, which is rectified by silicon rectifier and stored in the capacitor and then enters the battery, so that the electromagnetic field intensity of electric vehicle is less than 0.4 μt. the purpose of eliminating the magnetic field in the shield is achieved. the motor radiation problem that harms human health for a long time is solved. and technical support is provided for the popularization of electric vehicles.

### DESCRIPTION OF DRAWINGS

FIG. 1 is a functional block diagram of this application;

FIG. 2 is the circuit schematic diagram of the electronic control system of this application;

FIG. 3 is the connection diagram of the applied power surge protector and the power cord;

FIG. 4 is the overall structure diagram of the electric vehicle of this application;

FIG. 5 is a structural block diagram of the cooling system of the driving motor of this application;

FIG. 6 is a schematic diagram of the overall structure of the first example of this application;

FIG. 7 is a schematic diagram of the overall structure of the second example of this application;

FIG. 8 is a schematic diagram of the overall structure of the third example of this application;

FIG. 9 is a partial structural diagram of the cooling system of the driving motor of this application;

FIG. 10 is a structural diagram of the eighth shield of this application;

FIG. 11 is a structural diagram of the ninth shield of this application;

FIG. 12 is a structural diagram of the first general shielding system of this application

FIG. 13 is a structural diagram of the second general shielding system of this application;

FIG. 14 and FIG. 15 are structural diagrams of the second catheter of this application;

FIG. 16 and FIG. 17 are structural diagrams of the third catheter of this application;

FIG. 18 and FIG. 19 are structural diagrams of the second ventilation pipe of this application;

FIG. 20 is a structural diagram of the first catheter of this application;

FIG. 21 and FIG. 22 are structural diagrams of the second air duct of this application;

FIG. 23 is a structural diagram of the first shield core of this application;

FIG. 24 is a structural diagram of the first, second and third shields of this application;

FIG. 25 is a structural diagram of the motor of this application;

FIG. 26 is a motor wire connection diagram of this application;

FIG. 27 is a stereogram of the fan of this application;

FIG. 28 is a side view of this application.

### DETAILED IMPLEMENTATION MODE

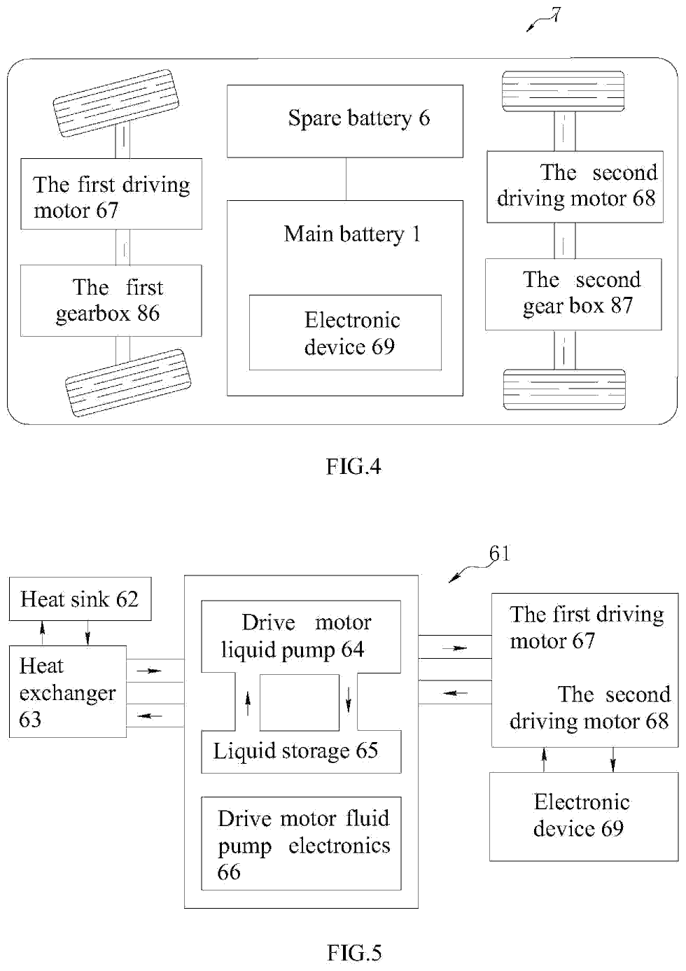

In FIG. 4 and FIG. 28, the first driving motor 67 of electric vehicle 7 is matched with the first gear box 86, and the second driving motor 68 is matched with the second gear box 87. The backup battery 6 supplies power to the main battery 1, which supplies power to the electronic devices 69 of the electric vehicle 7 and drives the first drive motor 67 and the second drive motor 68 to push the electric vehicle 7 to move. The motor housing 9 is arranged on the third bracket 141. The third screw 142 and the 4th screw 143 are used to fix the third bracket 141 on the electric vehicle 7. The motor housing 9 conducts the energy from the grounding wire of the first total shielding body 3 or the second total shielding body 47 inside the motor housing 9 to the body of the electric vehicle 7 by connecting the third bracket 141, which is made of conductive metal material.

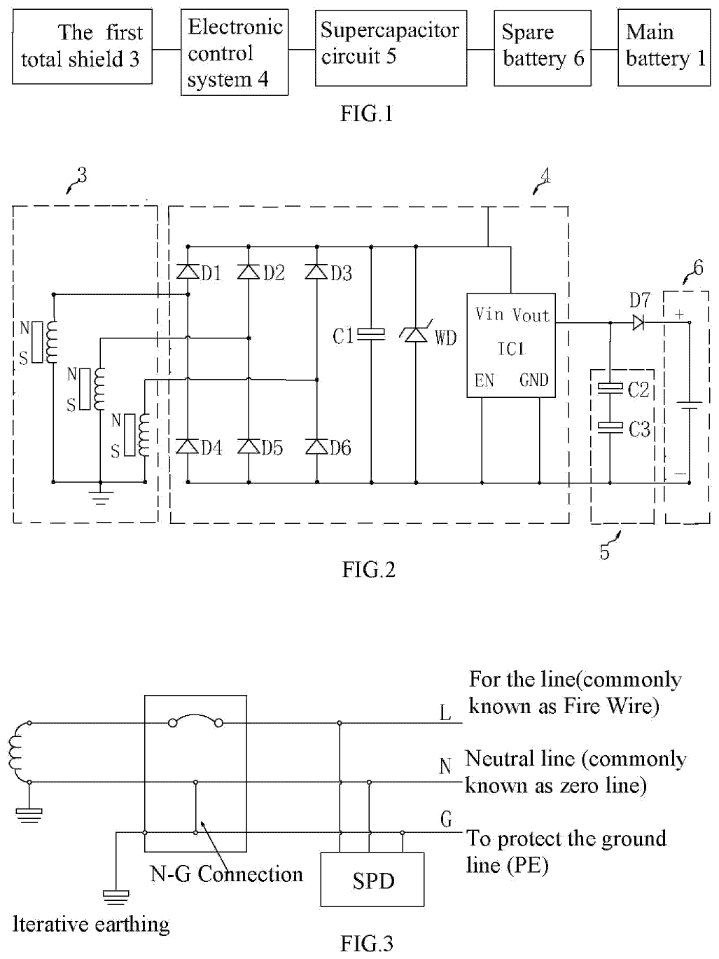

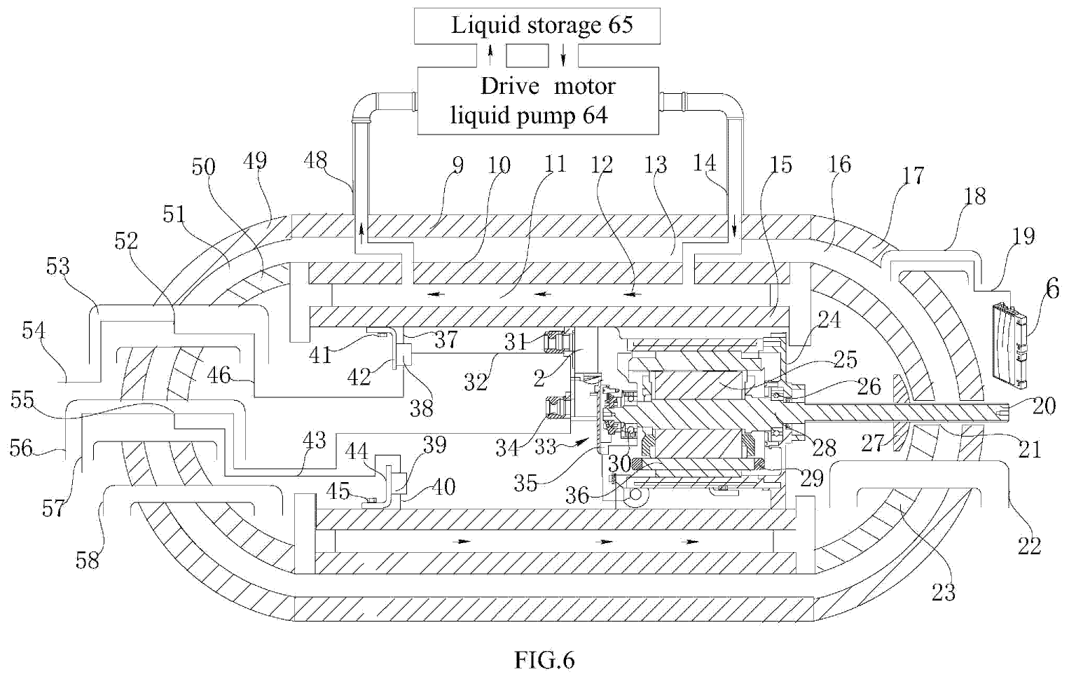

In FIG. 1, FIG. 2 and FIG. 6, the first total housing body 3 or the second total housing body 47 arranged in the housing 9 is connected with an electronic control system 4. The electronic control system 4 is connected with a super capacitor circuit 5. And the super capacitor circuit 5 is connected with a backup battery 6. The backup battery 6 is connected with the main battery 1, and the first total aging body 3 or the second total aging body 47 is connected with the electronic control system 4, which is used to generate the induced electromotive force through the motor controller 6 and motor 33 inside the first total shielding body 3 or the second total shielding body 47 relative to the first total shielding body 3 or by the movement of the coil winding of the second total shielding body 47; The electronic control system 4 filters, rectifies, multiplies and stabilizes the received induced electromotive force from the first total shielding body 3 or the second total shielding body 47, obtaining a suitable stable voltage and inputting it into the super capacitor circuit 5. Charge is stored in a super capacitor 5, which is connected to and charges a backup battery 6 of an electric vehicle 7. The backup battery 6 charges the main battery 1 of the electric vehicle. In the silicon rectifier circuit, three-phase full-wave rectifier diodes are D1, D2, D3, D4, D5 and D6. The voltage-stabilizing circuit comprise a voltage-stabilizing diode WD with a filter capacitor C1 and a DC voltage conversion integrate circuit IC1; that super-capacitor circuit 5 comprises two single capacitors C2 and C3 connected in series; the diode D7 prevents the current of the backup battery 6 from flowing back to the total shielded power generation system; and the IC1 is a wide input voltage DC-DC conversion integrated circuit.

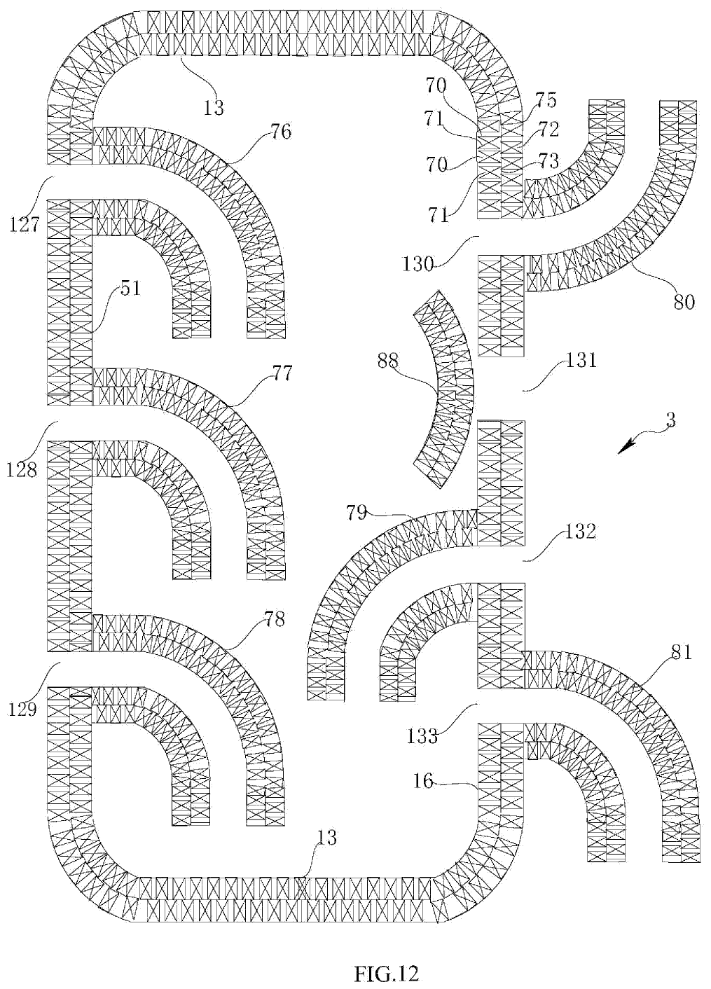

In FIG. 6 and FIG. 12, the first total shielding body 3 arranged in the shell 9 consists of the first shield 13, the second shield 16, the third shield 51 and the 4th shield 76, the 5th shield 77, the 6th shield 78, the 7th shield 79, the 8th shield 80, The ninth shield 81, the tenth shield 67, the eleventh shield 135 and the twelfth shield 136. The first total shielding body 3 coil connection mode is single-phase, two-phase, three-phase or multi-phase, so as to reduce the ripple coefficient of the output voltage waveform accordingly; Coil windings in the first total shielding body 3 structure are output after being connected in series or in parallel; The connection makes the electromagnetic field inside the first total shielding body 3 unable to be in the first outlet 127, the second outlet 128, the third outlet 129, the 4th outlet 130, The 5th outlet 131, the 6th outlet 132 and the 7th outlet 133 leaked out.

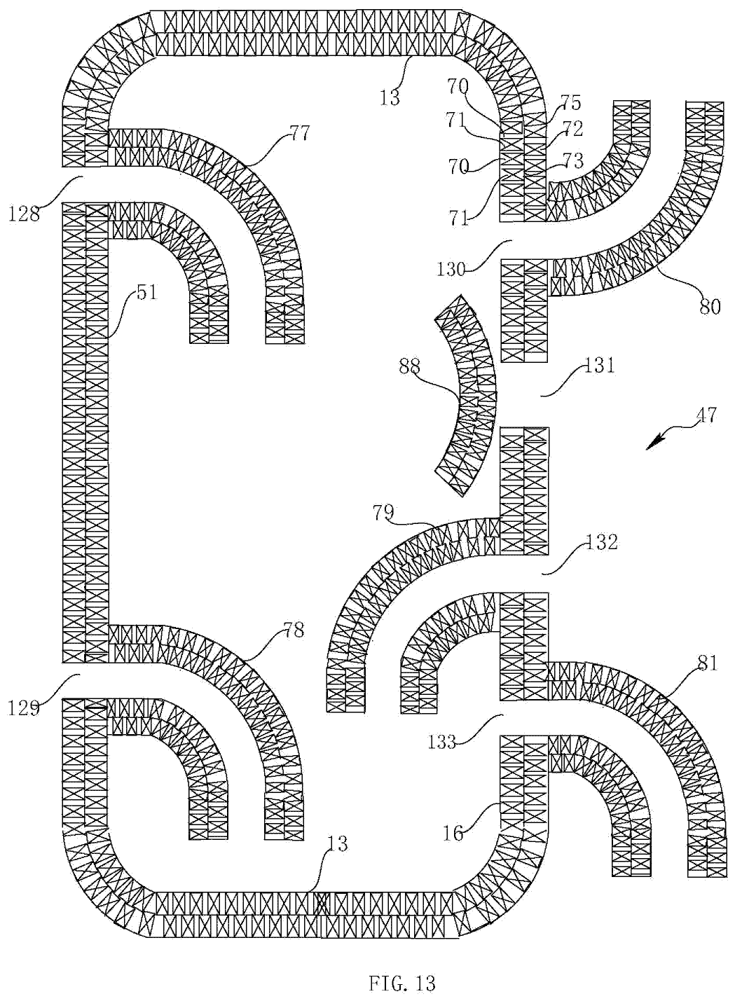

In FIG. 6 and FIG. 13, the second total shielding body 47 arranged inside the housing 9 consists of the first shield 13, the second shield 16, the third shield 51, the fifth shield 77, The 6th shield 78, the 7th shield 79, the 8th shield 80, the 9th shield 81, the 10th shield 145, the 11th shield 135 and the 12th shield 136. The second total shielding body 47 coil connection mode can be single-phase, two-phase, three-phase or more phases, so as to reduce the ripple coefficient of the output voltage waveform accordingly; Coil windings in the second total shielding body 47 structure are output after being connected in series or in parallel; The connection prevents the electromagnetic field inside the second total shielding body 47 from leaking out at the second outlet 128, the third outlet 129, the 4th outlet 130, the 5th outlet 131, the sixth outlet 132 and the 7th outlet 133.

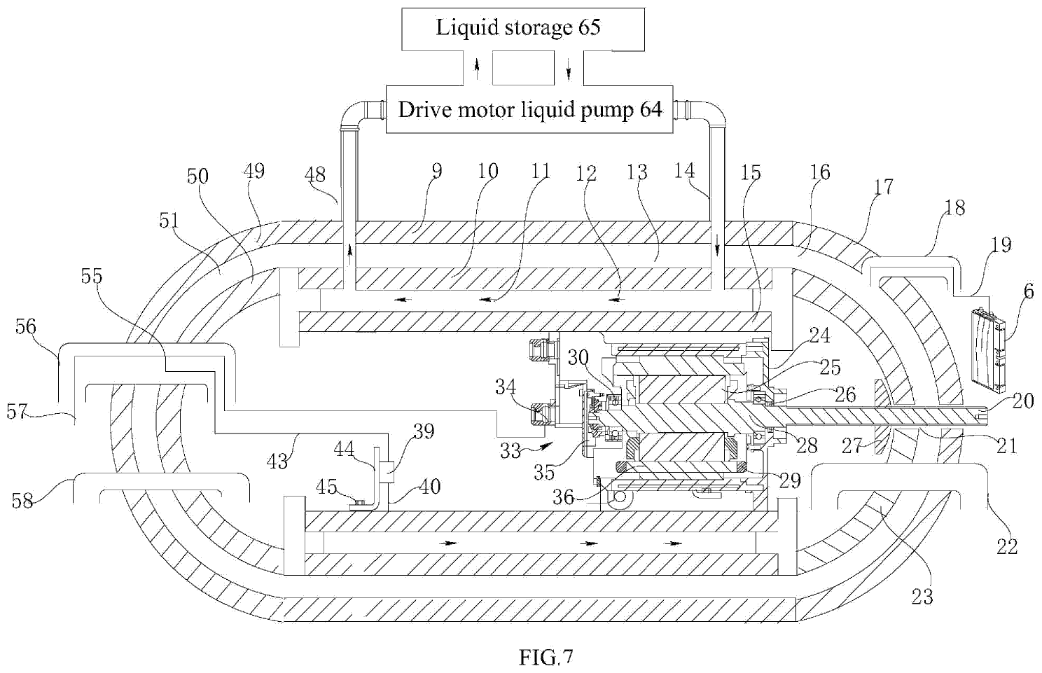

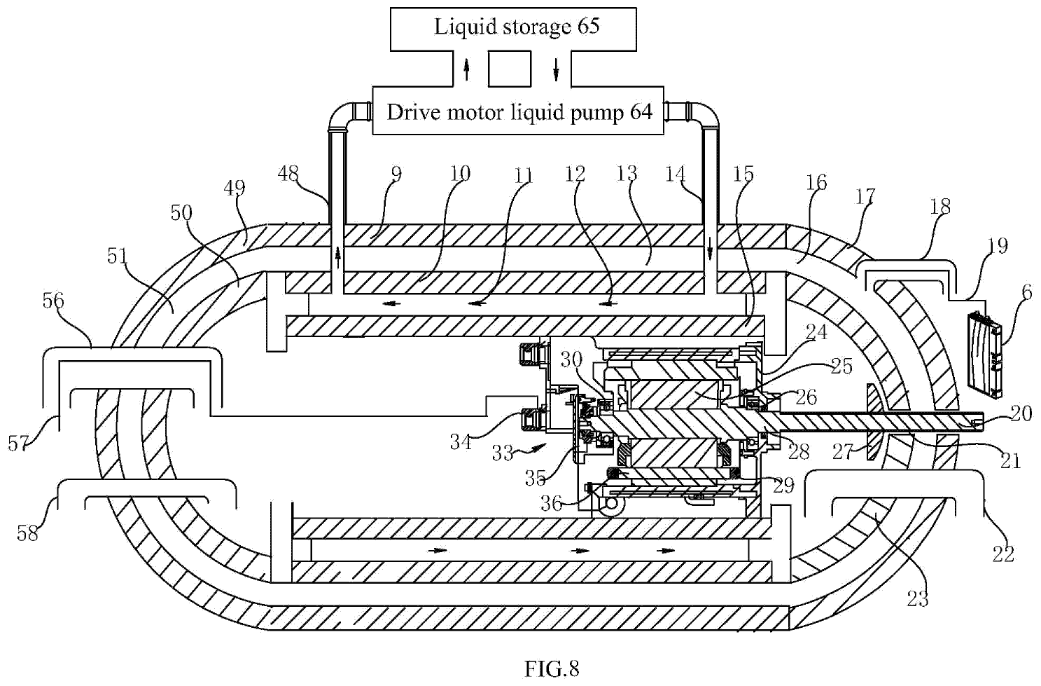

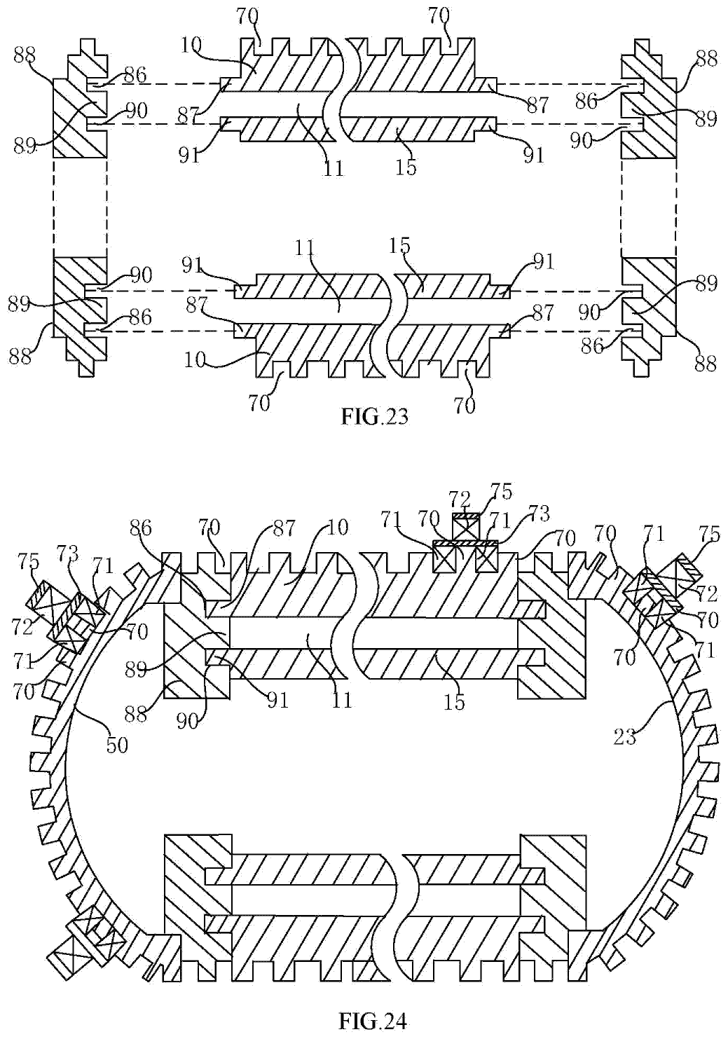

In FIG. 6, FIG. 7, FIG. 8, FIG. 12, FIG. 13, FIG. 23 and FIG. 24, in the first total shielding body 3 or the second total shielding body 47, The stator core 10 of the first shield 13 is cylindrical, and the inner core 15 of the first shield stator core 10 is cylindrical. The first shield stator core 10 and the first shield inner core 15 are made of metal materials, especially silicon steel sheets which are core punching materials. A plurality of square slots 70 are arranged in sequence on the outer surface of the first shield stator core 10 along the circumferential direction, and the first coil 71 is embedded in each square slot 70; The second coil 72 is arranged at the upper part between every two adjacent first coils 71, and the second coil 72 and the first coil 71 form a shield; the outer of the first coil 71 is encapsulated with the first layer sealing resin 73, and the outer of the second coil 72 is sealed with the second layer sealing resin 75. According to the need, a combination of the first coil 71 and the second coil 72 is added outside the second coil 72.

In FIG. 6, FIG. 7, FIG. 8, FIG. 12, FIG. 13, FIG. 23 and FIG. 24, in the first total shielding body 3 or the second total shielding body 47, the second shield 16 has a hemispherical structure, and the second shield core 23 has a hemispherical structure. The second shield core 23 is made of metal material, especially silicon steel sheet which are core punching materials, and a plurality of square grooves 70 are arranged on the outer surface of the second shield iron core 23 in sequence along the center direction, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need, a combination of the first coil 71 and the second coil 72 is added outside the second coil 72.

In FIG. 6, FIG. 7, FIG. 8, FIG. 12, FIG. 13, FIG. 23 and FIG. 24, in the first total shielding body 3 or the second total shielding body 47, the third shield 51 has a hemispherical structure, and the third shield core 50 has a hemispherical structure. The third shield core 50 is made of metal material, especially silicon steel sheet which are core punching materials, and a plurality of square grooves 70 are arranged on the outer surface of the third shield core 50 in sequence along the center direction, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75, and a combination of multiple layers of the first coil 71 and the second coil 72 is added outside the second coil 72 according to the need.

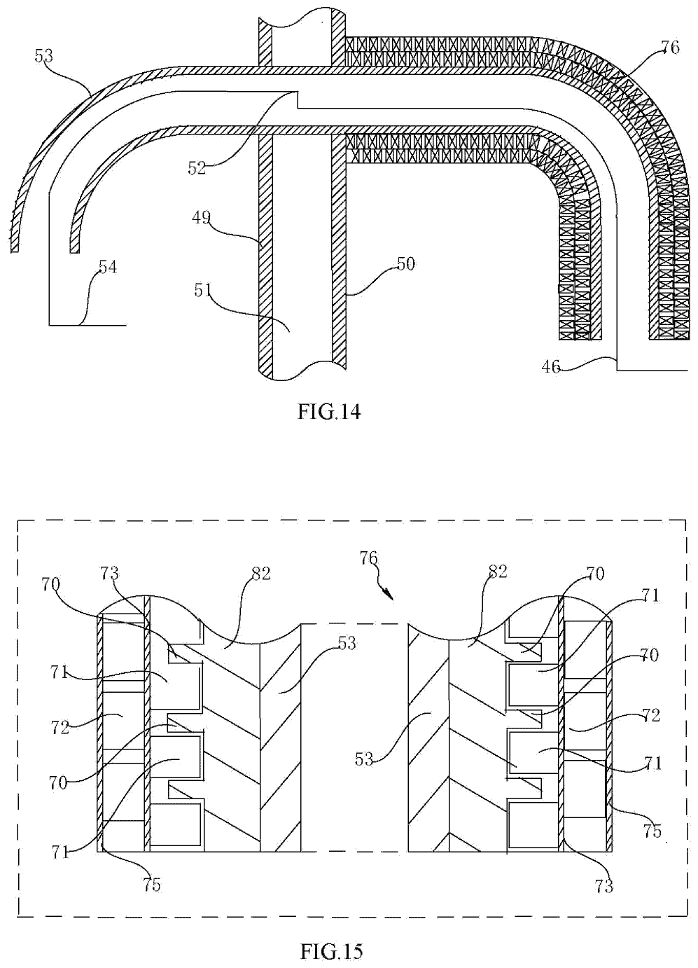

In FIG. 6, FIG. 12, FIG. 14 and FIG. 15, in the first total shielding body 3, the second conduit 53 is a non-metallic circular pipe. Part of the second conduit 53 inside the second semi-circular stator core 50 is arranged as the 4th shield system 76, and the 4th shield 76 is in the shape of a ring. The part of the second conduit 53 outside the second semicircular stator core 50 is bent by 90 degrees, and the parts of the second conduit 53 and the 4th shield 76 inside the second semicircular stator core 50 are bent by 90 degrees. The 4th shield 76 is made of metal material, especially silicon steel sheet, which is a core punching material. A plurality of circumferential square grooves 70 is arranged on the outer surface of the 4th shield system 76 in sequence, and the first coil 71 is embedded in each square groove 70. The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need, a combination of the first coil 71 and the second coil 72 is added outside the second coil 72.

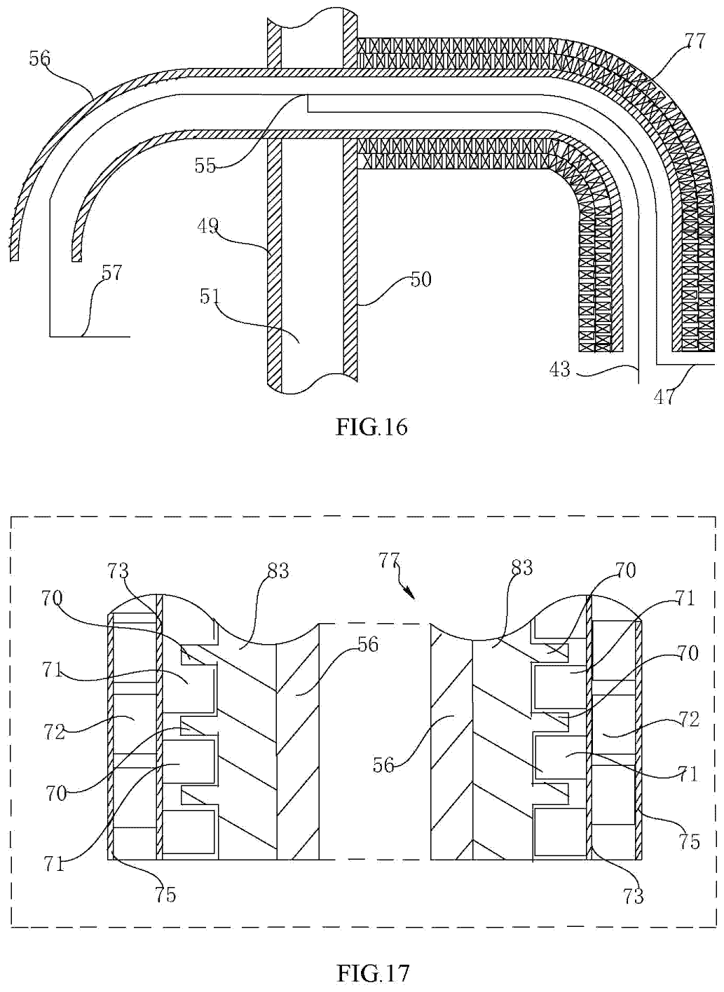

In FIG. 6, FIG. 7, FIG. 8, FIG. 12, FIG. 13, FIG. 16 and FIG. 17, in the first total shielding body 3 or the second total shielding body 47, the third conduit 56 is a nonmetallic circular tube. The fifth shield 77 is arranged at the part of 56 inside of the second semi-circular stator core 50 by the third conduit, and the fifth shield 77 is in a ring shape. The part of the third conduit 56 outside the second semicircular stator core 50 is bent by 90 degrees, and the parts of the third conduit 56 and the 5th shield 77 inside the second semicircular stator core 50 are bent by 90 degrees. On the outer surface of the 5th shield 77, a plurality of circumferential square grooves 70 are arranged in sequence, and the square grooves 70 of the 5th shield 77 are made of metal materials, especially silicon steel sheets, which is a core punching material, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need, a combination of the first coil 71 and the second coil 72 is added outside the second coil 72.

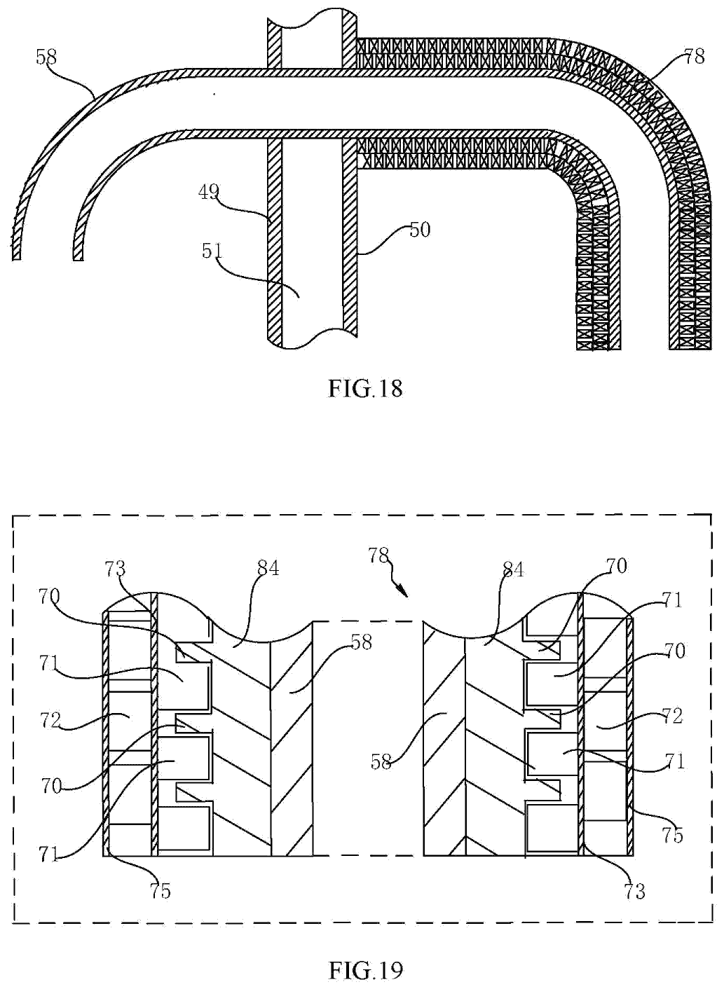

In FIG. 6, FIG. 7, FIG. 8, FIG. 12, FIG. 13, FIG. 18 and FIG. 19, in the first total shielding body 3 or the second total shielding body 47, the second vent pipe 58 is a nonmetallic circular pipe. A sixth shield 78 is arranged on the part of the second vent pipe 58 which enters the second semi-circular stator core 50, and the sixth shield 78 is annular. The part of the second vent pipe 58 outside the second semicircular stator core 50 is bent by 90 degrees, and the parts of the second vent pipe 58 and the sixth shield 78 inside the second semicircular stator core 50 are bent by 90 degrees. The square slots 70 of the sixth shield 78 are made of metal materials, especially silicon steel sheets which are core punching materials. A plurality of circumferential square slots 70 are arranged on the outer surface of the sixth shield 78 in sequence, and the first coil 71 is embedded in each square slot 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need, a combination of the first coil 71 and the second coil 72 is added outside the second coil 72.

In FIG. 6, FIG. 7, FIG. 8, FIG. 12, FIG. 13, FIG. 21 and FIG. 22, in the first total shielding body 3 or the second total shielding body 47, the first vent pipe 22 is a nonmetallic round pipe. The 7th shield 79 is arranged at the part of the first vent pipe 22 entering the first semicircular stator core 23, and the 7th shield 79 is in the shape of a ring. The first vent pipe 22 is bent by 90 degrees outside the first semi-circular stator core 23, and the first vent pipe 22 and the 7th shield 79 are bent by 90 degrees inside the first semi-circular stator core 23. On the outer surface of the 7th shield 79, a plurality of square grooves 70 are arranged in sequence along the circumferential direction, and the square grooves 70 of the 7th shield 79 are made of metal materials, especially silicon steel sheets, which are core punching materials, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75, and a combination of multiple layers of the first coil 71 and the second coil 72 is added outside the second coil 72 according to the need.

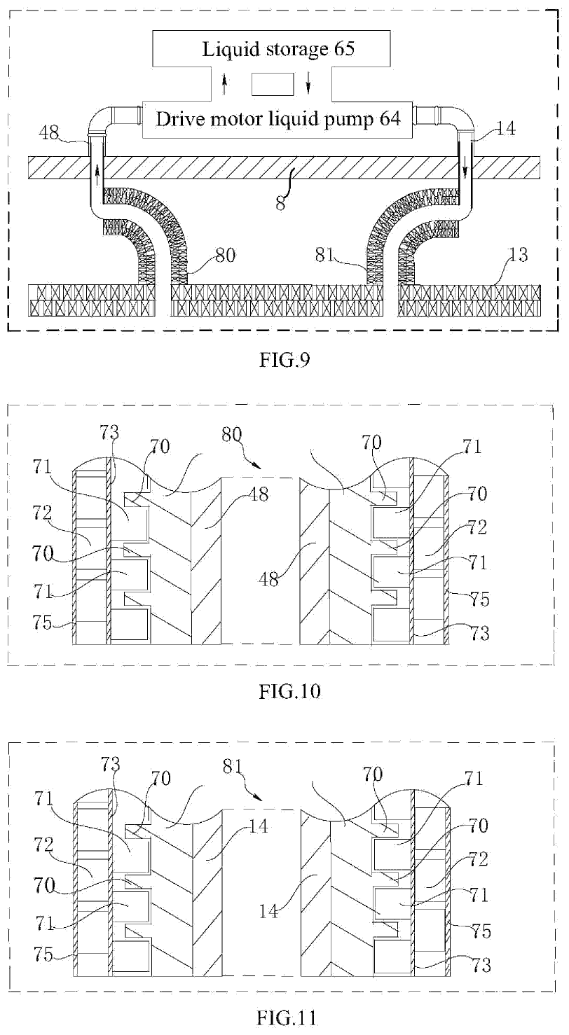

In FIG. 6, FIG. 7, FIG. 8, FIG. 9, FIG. 10, FIG. 12 and FIG. 13, in the first total shielding body 3 or the second total shielding body 47, the output pipeline 48 of the motor fluid pump is a non-metallic circular pipe. The 8th shield 80 is arranged on the part where the motor fluid pump output pipeline 48 enters between the shell 9 and the outside of the core 10. The 8th shield 80 is in the shape of a ring, and the parts of the motor fluid pump output pipeline 48 and the 8th shield 80 outside the outside of the core 10 are bent by 90 degrees. On the outer surface of the 8th shield 80, a plurality of square grooves 70 are arranged in sequence along the circumferential direction, and the square grooves 70 of the 8th shield 80 are made of metal materials, especially silicon steel sheets, which are core punching materials, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need, a combination of the first coil 71 and the second coil 72 is added outside the second coil 72.

In FIG. 6, FIG. 7, FIG. 8, FIG. 9, FIG. 11, FIG. 12 and FIG. 13, in the first total shielding body 3 or the second total shielding body 47, the input pipe 14 of the fluid pump of the driving motor is a non-metallic circular pipe. The ninth shield 81 is arranged on the part where the drive motor fluid pump input pipeline 14 enters between the shell 9 and the outside of the iron core 10. The ninth shield 81 is in a ring shape, and the parts of the drive motor fluid pump input pipeline 14 and the ninth shield 81 outside the outside of the iron core 10 are bent by 90 degrees. On the outer surface of the ninth shield 81, a plurality of square grooves 70 are arranged in sequence along the circumferential direction, and the square grooves 70 of the ninth shield 81 are made of metal materials, especially silicon steel sheets, which are core punching materials, and the first coil 71 is embedded in each square groove 70; The second coil 72 is arranged at the upper part between every two adjacent first coils 71, and the second coil 72 and the first coil 71 form a shield; the first coil 71 is encapsulated with the first layer sealing resin 73, the second coil 72 is encapsulated with the second layer sealing resin 75, and a combination of multiple layers of the first coil 71 and the second coil 72 is added outside the second coil 72 according to the need.

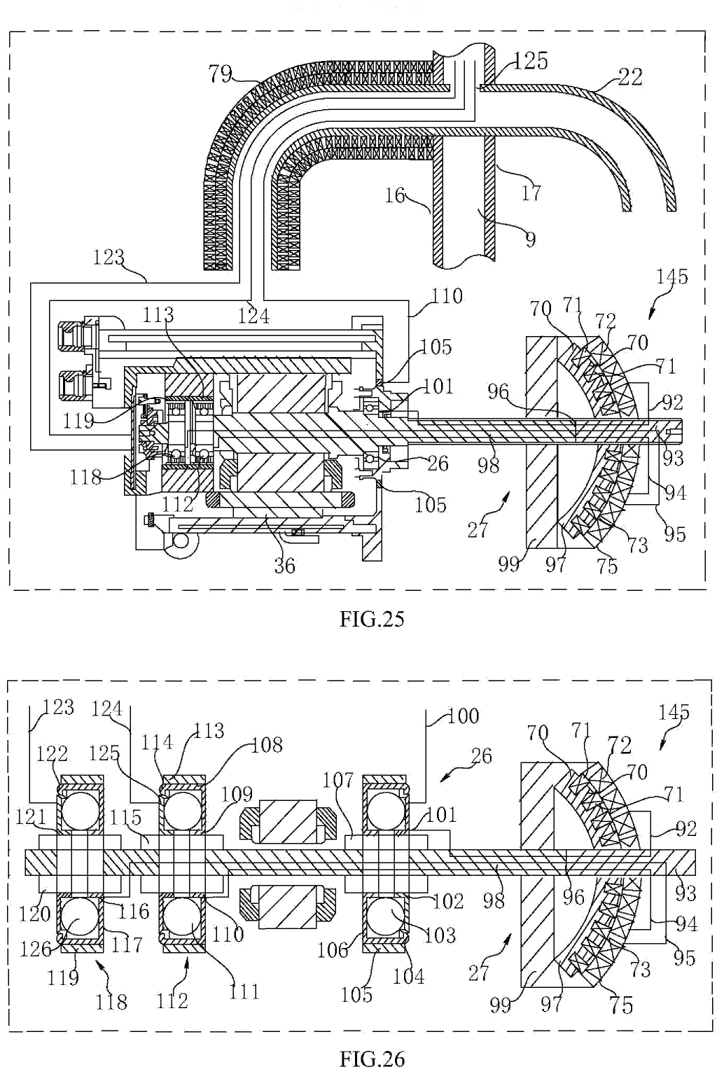

In FIG. 6, FIG. 7, FIG. 8, FIG. 12, FIG. 13, FIG. 25 and FIG. 26, in the first total shielding body 3 or the second total shielding body 47, the tenth shield 145 is in the shape of a disk. On the outer surface of the tenth shield 145, a plurality of square grooves 70 are arranged outwards along the center of the circle in sequence, and the square grooves 70 of the tenth shield 67 are made of metal materials, especially silicon steel sheets which are core punching materials, and the first coil 71 is embedded in each square groove 70; The second coil 72 is arranged at the upper part between every two adjacent first coils 71, and the second coil 72 and the first coil 71 form a shield; The first coil 71 is encapsulated with the first layer sealing resin 73, and the second coil 72 is encapsulated with the second layer sealing resin 75. According to the need a combination of multiple layers of the first coil 71 and the second coil 72 is added outside the second coil 72.

In FIG. 6, FIG. 14, FIG. 15, FIG. 16 and FIG. 17, in the first total shielding body 3 or the second total shielding body 47, the first support 42 is fixed on the inner surface of the inner side 15 of the stator core by the first bolt 41, and the signal line and control line protector 38 are fixed on the first support 42. After entering the second conduit 53, the signal line 54 is connected with the first wire 46 of signal line and the control line protector 38 at the first connection point 52 of the signal line before entering the third shield core 50. The signal line, the second wire 32 of the control line protector 38 are connected with the signal line junction box 31 of the motor controller 6, which consists of the eleventh shield 135.

In FIG. 6, FIG. 3, FIG. 7, FIG. 16 and FIG. 17, in the first total shielding body 3 or the second total shielding body 47, the second support 44 is fixed on the inner surface of the inner side 15 of the stator core by the second bolt 45. The power surge protector 39 is fixed on the second support 44. After entering the third conduit 56, At the first connection point 55 of the power cord, the power cord 57 is connected in parallel with the first connection cable 43 of the second power surge protector before entering the housing 9. Then, the power cord 57 enters the inside of the housing 9 and is connected with two DC input terminals 34 of the motor controller 6, and the protective ground wire 40 of the power surge protector 39 is connected with the inner surface of the inner side 15 of the stator core, which consists of the twelfth shield 136.

In FIG. 23, FIG. 24, FIG. 6, FIG. 7, FIG. 8, FIG. 12 and FIG. 13, the stator core outer side 10 and the stator core inner side 15 are arranged on the inside of the first total shield 3 or the second total shield 47, and a pair of end caps 88 are arranged at the ends of the stator core outer side 10 and the stator core inner side 15. The end caps 88 are ring-shaped; the inner side 15 of the stator core is a cylindrical structure. The outer side 10 of the stator core is a cylindrical structure. the end caps 88 have a ring-shaped grooving 86. the end caps 88 have a ring-shaped grooving 90. the outer side 10 of the core includes a pair of snap rings 87. The inner side 15 of the stator core includes a pair of snap rings 91. The snap rings 87 are arranged in the grooving 86. The snap rings 91 are arranged in the grooving 86. The snap ring 87 is arranged in the grooving 86, and the snap ring 91 is arranged in the grooving 90.

In FIG. 25 and FIG. 26, the first coil 71 and the second coil 72 of the tenth shield 145 are arranged on the core 97. The core 97 is arranged on a fan 99 which is arranged on the first transmission shaft 93 of the motor 33, and the diameter of the fan 99 is larger than that of the transmission shaft channel 21. The diameter of the core 97 is larger than that of the transmission shaft channel 21. The diameter of the tenth shield 145 is larger than that of the transmission shaft channel 21, and a plurality of circumferential square grooves 70 are arranged on the outer surface of the core 97 in sequence. The first coil 71 is embedded in each slot, and the second coil 72 is arranged in the upper part between two adjacent first coils 71, and the second coil 72 and the first coil 71 form a shield. The first coil 71 is encapsulated with the first layer sealing resin 73, and the second coil 72 is encapsulated with the second layer sealing resin 75, and the first coil 71 and the second coil 72 windings are enameled wire windings. Multiple layers of the second coil 72 can be added to the outside of the first coil 71, and the tenth shield 145 connected above prevents the electromagnetic field generated by the motor controller 2 and the motor 33 from leaking out of the outer shield 9 through the gap of the transmission shaft channel 21 after the motor 33 is energized.

In FIG. 25 and FIG. 26, the transmission shaft 20 consists of the first transmission shaft 93 and the second transmission shaft 98. The second transmission shaft 98 is a metal body, and the first transmission shaft 93 is made of non-magnetic material. The first transmission shaft 93 and the second transmission shaft 98 are connected at the third connection point 96, and the third connection point 96 cannot enter the core 97. The 4th connecting line 92 connects with the first coil 71 and the second coil 72 passing through the first transmission shaft 93 and the second transmission shaft 98, and is connected with the first bearing 26 at the first bearing connection point 101 which is on the first bearing inner ring 102; The non-conductive and non-magnetically conductive first insulator 107 is arranged between the first bearing inner ring 102 and the second transmission shaft 98, and the non-conductive and non-magnetically conductive second insulator 105 is arranged outside the first bearing outer cover 106. The first connecting line 100 of the motor is connected with the first bearing cover 106. The external first connecting line 100 of the motor is connected with the second shield 16 through the first line outlet 125 of the 7th shield 79 of the first vent pipe 22. The first bearing 26 consists of a bearing inner ring 102, a bearing bead of the first bearing 103, the first bearing protrusion 104 defining the inner ring and the first bearing outer cover 106. The second super bearing 30 includes the third bearing 112 and the 4th bearing 118. The 5th connecting line 94 connects with the first coil 71 and the second coil 72 passing through the first transmission shaft 93 and the second transmission shaft 98 is connected with the third bearing 112 at the third bearing connection point 110 on the third bearing inner ring 109. A non-conductive and non-magnetic third isolator 115 is arranged between the third bearing inner ring 109 and the second transmission shaft 98. The 4th insulator 113 which is non-conductive and non-conductive is arranged on the outside of the third bearing outer cover 108, and the external connection line 124 of the motor is connected with the third bearing outer cover 108. The external connection line 124 of the motor is connected with the second shield 16 through the first line outlet 125 of the 7th shield 79 of the first vent pipe 22. The third bearing consists of the third bearing inner ring 109, the third bearing bead 111, the third bearing protrusion 114 defining the inner ring and the third bearing outer cover 108. The sixth connecting line 95 connects with the first coil 71 and the second coil 72 and passes through the first transmission shaft 93 and the second transmission shaft 98. And the 4th bearing 118 is connected at the 4th bearing connection point 116 which is on the 4th bearing inner ring 121. The non-conductive and non-magnetic 5th insulator 120 is arranged between the 4th bearing inner ring 121 and the second transmission shaft 98, and the non-conductive and non-magnetic sixth insulator 119 is arranged outside the 4th bearing outer cover 117. The external motor the third connecting line 123 is connected with the third bearing outer cover 117. The external connection line 123 of the motor is connected with the second shield 16 through the first line outlet 125 of the 7th shield 79 of the first vent pipe 22. The 4th bearing 118 consists of the 4th bearing inner ring 121, the bearing bead of the 4th bearing 126, the 4th bearing bulge 122 defining the inner ring and the bearing outer cover of the 4th bearing 117.

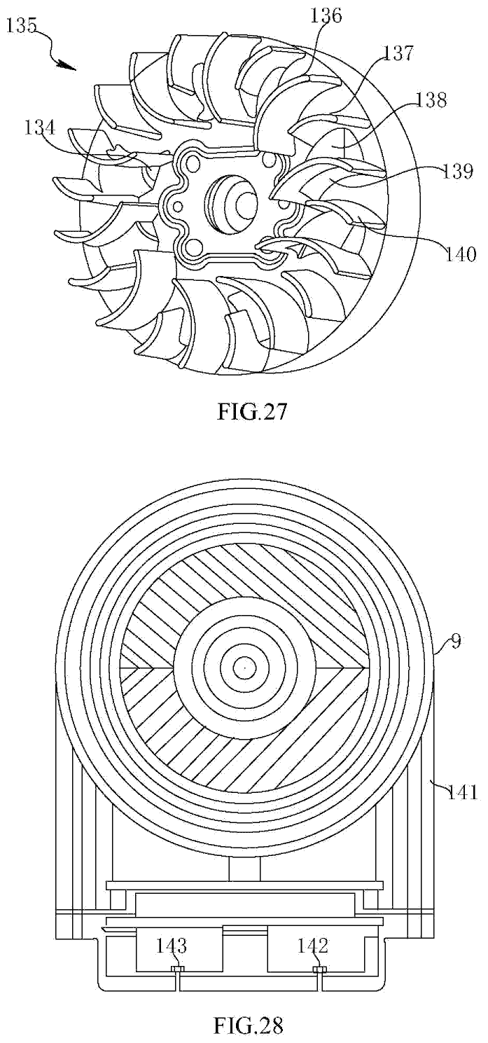

In FIG. 27, the fan 135 includes the first blade 140 and the second blade 138. The first blade 140 includes the third blade 136 and the fourth blade 137. the first blade 140 and the second blade 138 are located at the front of the bottom cover, and the second blade 138 is disposed between the third blade 136 and the first blade 140. The first blade 140 is a centrifugal fan blade, and the second blade 138 is close to an axial fan blade. The outlet of the second blade 138 can enter the first air duct 22, and the second blade 138 has a primary tangential air inlet 139 and a secondary radial air inlet 134. The second blade 138 has a radial air inlet 134 and a tangential air inlet 139, which form negative pressure in the central area of the fan 135. The outside cold air continuously enters the fan 135, and the airflow entering the fan 135 is divided into primary and secondary paths under the action of the second blade 138.

In FIG. 5, a driving motor cooling system 61 includes a heat sink 62, a heat exchanger 63, a drive motor liquid pump 64, a liquid storage 65, the second electronic device 66, the first driving motor 67 and the second driving motor 68. Fluid is pumped between the liquid storage 65 and the heat exchanger 63, which exchanges heat from the fluid with coolant and transports the coolant to the heat sink 62 for cooling. The coolant channel 11 is filled with coolant 12, and the drive motor fluid pump 64 is controlled by an electronic device 66. The second electronic device 66 includes a digital computer, a memory and data processing and control components.

The electronic device 69 receives power from the main battery 1 and supplies power to the first driving motor 67 and the second driving motor 68. The electronic device 69 includes power electronics and control electronics. The power electronics can include an inverter, and the control second electronics 66 includes a processing circuit and a memory. The processing circuit can be a central processing unit, a custom control circuit, or other circuits configured to execute software instructions and process data. The memory may include RAM, ROM, DRAM, static RAM, flash RAM, flash ROM, and other types of memory capable of storing software instructions and data.

The drive motor fluid pump 64 has a drive motor fluid pump output pipeline 48 and a drive motor fluid pump input pipeline 14, and the drive motor cooling system 61 includes a fluid circulation pipeline. The drive motor fluid pump electronic device 66 guides the drive motor fluid pump 64 to pump fluid from the fluid storage 65 into the fluid supply fluid receiving end coolant channel 11, and the fluid is recycled into the drive motor fluid pump 64 via the drive motor fluid pump output pipeline 48.

### The First Embodiment

In FIG. 6, FIG. 3 and FIG. 12, a motor controller 2 and a motor 33 are arranged in the first total shielding body 3, and the motor controller 2 is fixedly connected to the radial periphery of the motor 33. The motor controller 2 outputs three-phase power to the motor 33, and then drives the motor 33 to rotate. The motor 33 includes a motor stator core 29 and a stator coil 36, and a motor rotor 28 is arranged in the motor 33, and the rotor coil 25 is fixed on the motor rotor 28. The motor spindle 20 is connected with the motor rotor 28, the first bearing 26 is arranged on the front-end cover 24, and the second super bearing 30 is arranged on the rear end cover 35. The motor spindle 20 passes through the first bearing 26 and the second super bearing 30, and the second super bearing 30 includes the third bearing 112 and the 4th bearing 118. The first support 42 is fixed on the inner surface of the inner side 15 of the stator core by the first bolt 41, and the signal line and control line protector 38 are fixed on the first support 42. After the signal line 54 enters the second conduit 53, it is connected to the first conducting wire of the signal line and the control line protector at the first connection point 52 38 before entering the shielding system 8. The second wire 32 of the signal line and control line protector 38 is connected with the signal line junction box 31 of the motor controller 6, and the protective ground wire 37 of the signal line and control line protector 38 is connected with the inner surface of the stator core 15. By connecting the inner surface of the inner core 15, the absorbed energy is channeled to the inner core 15. The second support 44 is fixed on the inner surface of the inner side 15 of the stator core by the second bolt 45, and the power surge protector 39 is fixed on the second support 44. After entering the third conduit 56, the power cord 57 is connected in parallel with the first connection line 43 of the second power surge protector at the first connection point 55 of the power cord before entering the housing 9. Then, the power cord 57 enters the inside of the casing 9 and is connected with two DC input terminals 34 of the motor controller 6, and the protective ground wire 40 of the power surge protector 39 is connected with the inner surface of the stator core inner side 15 to channel the absorbed energy to the stator core inner side 15. The drive motor fluid pump 64 has a drive motor fluid pump output pipeline 48 and a drive motor fluid pump input pipeline 14. The drive motor cooling system 61 includes a fluid circulation pipeline, and the drive motor fluid pump electronics 66 guide the drive motor fluid pump 64 to pump fluid from the fluid storage 65 into the fluid supply fluid receiving end coolant channel 11. The fluid is recycled to the drive motor fluid pump 64 via the drive motor fluid pump output pipeline 48.

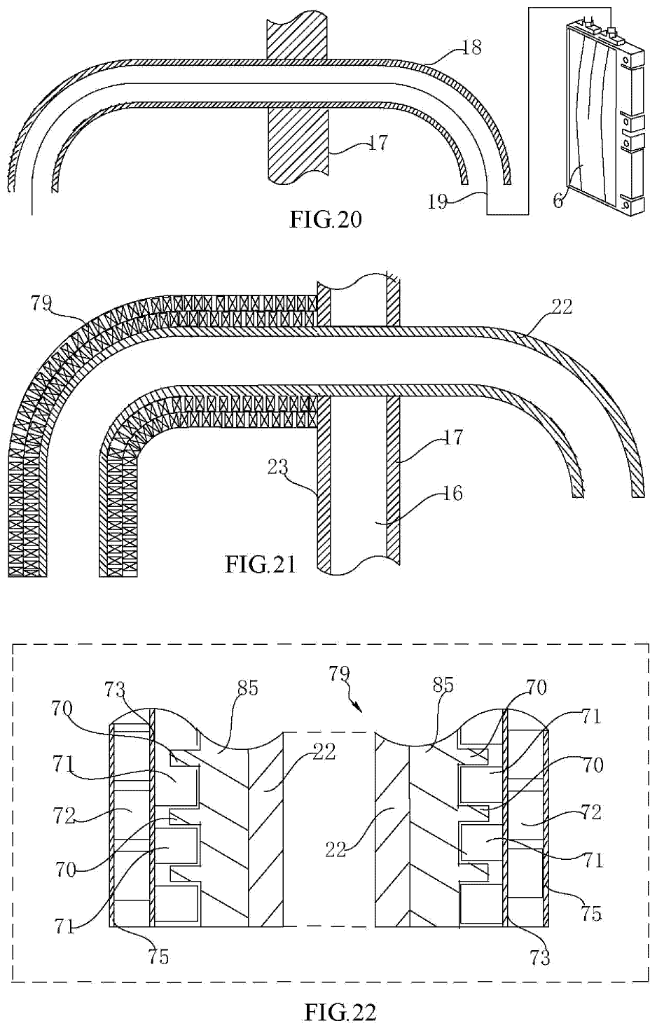

In FIG. 6 and FIG. 20, the first conduit 18 passes through the semi-circular shell 17 outside the first hemispherical stator core 23 and is fixed on the semi-circular shell 17. A connecting line 19 of the first total shielding body 3 passes through the first conduit 18 and is connected with the backup battery 6 through the electronic control system 4.

### The Second Embodiment

In FIG. 7 and FIG. 13, a motor 33 is arranged in the second total housing body 47, and the motor 33 includes a motor stator core 29 and a stator coil 36. The motor 33 is internally arranged with a motor rotor 28. The rotor coil 25 is fixed on the motor rotor 28. The motor spindle 20 is connected with the motor rotor 28. The first bearing 26 is arranged on the front-end cover 24, and the second bearing 30 is arranged on the rear end cover 35. The motor spindle 20 passes through the first bearing 26 and the second super bearing 30, and the second super bearing 30 includes the third bearing 112 and the 4th bearing 118. The second support 44 is fixed on the inner surface of the inner side 15 of the stator core by the second bolt 45, and the power surge protector 39 is fixed on the second support 44. After entering the third conduit 56, the power cord 57 is connected in parallel with the first connection cable 43 of the second power surge protector at the first connection point 55 of the power cord before entering the housing 9. Then, the power cord 57 enters the inside of the casing 9 and is connected with two DC input terminals 34 of the motor controller 6, and the protective ground wire 40 of the power surge protector 39 is connected with the inner surface of the stator core inner side 15 to channel the absorbed energy to the stator core inner side 15. The drive motor fluid pump 64 has a drive motor fluid pump output pipeline 48 and a drive motor fluid pump input pipeline 14. The drive motor cooling system 61 includes a fluid circulation pipeline, and the drive motor fluid pump electronics 66 guide the drive motor fluid pump 64 to pump fluid from the fluid storage 65 into the fluid supply fluid receiving end coolant channel 11. The fluid is recycled to the drive motor fluid pump 64 via the drive motor fluid pump output pipeline 48.

In FIG. 7 and FIG. 20, the first conduit 18 passes through the semi-circular shell 17 outside the first hemispherical stator core 23 and is fixed on the semi-circular shell 17. A connecting line 19 of the total shielding body 3 passes through the first conduit 18 and is connected with the backup battery 6 through the electronic control system 4.

### The Third Embodiment

In FIG. 8 and FIG. 13, a motor 33 is arranged in the second total shielding body 47, and the motor 33 includes a motor stator core 29 and a stator coil 36. The motor 33 is internally arranged with a motor rotor 28. The rotor coil 25 is fixed on the motor rotor 28. The motor spindle 20 is connected with the motor rotor 28. The first bearing 26 is arranged on the front-end cover 24, and the second bearing 30 is arranged on the rear end cover 35. The motor spindle 20 passes through the first bearing 26 and the second super bearing 30, and the second super bearing 30 includes the third bearing 112 and the 4th bearing 118. After the power cord 57 enters the third conduit 56, the power cord 57 enters the inside of the housing 9 and is connected with two DC input terminals 34 of the motor controller 6. The driving motor fluid pump 64 has a driving motor fluid pump output pipeline 48 and a driving motor fluid pump input pipeline 14. The drive motor cooling system 61 includes a fluid circulation pipeline, and the drive motor fluid pump electronics 66 guides the drive motor fluid pump 64 to pump fluid from the fluid storage 65 into the fluid supply fluid receiving end coolant channel 11, and the fluid is recycled into the drive motor fluid pump 64 via the drive motor fluid pump output pipeline 48.

In FIG. 8 and FIG. 20, the first conduit 18 passes through the semi-circular shell 17 outside the first hemispherical stator core 23 and is fixed on the semi-circular shell 17. And the connecting wire 19 of the total shielding body 3 passes through the first conduit 18 and is connected with the backup battery 6 through the electronic control system 4.

1. A shield power generation system consisting of coil, control circuit, capacitor and battery, characterized in that:
the first total housing body (3) or the second total housing body (47) arranged in the housing (9) is connected with an electronic control system (4), the electronic control system (4) is connected with a super capacitor circuit (5), and the super capacitor circuit (5) is connected with a backup battery (6), the backup battery (6) is connected with the main battery (1), and the first total aging body (3) or the second total aging body (47) is connected with the electronic control system (4), which is used to generate the induced electromotive force through the motor controller (6) and motor (33) inside the first total shielding body (3) or the second total shielding body (47) relative to the first total shielding body (3) or by the movement of the coil winding of the second total shielding body (47); the electronic control system (4) filters, rectifies, multiplies and stabilizes the received induced electromotive force from the first total shielding body (3) or the second total shielding body (47), obtaining a suitable stable voltage and inputting it into the super capacitor circuit (5), charge is stored in a super capacitor (5), which is connected to and charges a backup battery (6) of an electric vehicle 7, the backup battery (6) charges the main battery (1) of the electric vehicle, in the silicon rectifier circuit, three-phase full-wave rectifier diodes are D1, D2, D3, D4, D5 and D6, the voltage-stabilizing circuit comprise a voltage-stabilizing diode WD with a filter capacitor C1 and a DC voltage conversion integrate circuit IC1; that super-capacitor circuit (5) comprises two single capacitors C2 and C3 connected in series; the diode D7 prevents the current of the backup battery (6) from flowing back to the total shielded power generation system; and the IC1 is a wide input voltage DC-DC conversion integrated circuit.

2. The shield power generation system consisting of coil, control circuit, capacitor and battery according to claim 1, characterized in that:
the first total shielding body (3) arranged in the shell (9) consists of the first shield (13), the second shield (16), the third shield (51) and the 4th shield (76), the 5th shield (77), the 6th shield (78), the 7th shield (79), the 8th shield (80), the ninth shield (81), the 10th shield (145), the eleventh shield (135) and the twelfth shield (136), the first total shielding body (3) coil connection mode is single-phase, two-phase, three-phase or multi-phase, so as to reduce the ripple coefficient of the output voltage waveform accordingly; coil windings in the first total shielding body (3) structure are output after being connected in series or in parallel; the connection makes the electromagnetic field inside the first total shielding body (3) unable to be in the first outlet (127), the second outlet (128), the third outlet (129), the 4th outlet (130), the 5th outlet (131), the 6th outlet (132) and the 7th outlet (133) leaked out, the second total shielding body (47) arranged inside the housing (9) consists of the first shield (13), the second shield (16), the third shield (51), the fifth shield (77), the 6th shield (78), the 7th shield (79), the 8th shield (80), the 9th shield (81), the 10th shield (145), the 11th shield (135) and the 12th shield (136), the second total shielding body (47) coil connection mode can be single-phase, two-phase, three-phase or more phases, so as to reduce the ripple coefficient of the output voltage waveform accordingly; coil windings in the second total shielding body (47) structure are output after being connected in series or in parallel; the connection prevents the electromagnetic field inside the second total shielding body (47) from leaking out at the second outlet (128), the third outlet (129), the 4th outlet (130), the 5th outlet (131), the sixth outlet (132) and the 7th outlet (133).

3. The shield power generation system consists of coil, control circuit, capacitor and battery according to claim 1, characterized in that:
in the first total shielding body (3) or the second total shielding body (47), the stator core (10) of the first shield (13) is cylindrical, and the inner core (15) of the first shield stator core (10) is cylindrical, the first shield stator core (10) and the first shield inner core (15) are made of metal materials, especially silicon steel sheets which are core punching materials, a plurality of square slots (70) are arranged in sequence on the outer surface of the first shield stator core (10) along the circumferential direction, and the first coil (71) is embedded in each square slot (70); the second coil (72) is arranged at the upper part between every two adjacent first coils (71), and the second coil (72) and the first coil (71) form a shield; the outer of the first coil (71) is encapsulated with the first layer sealing resin (73), and the outer of the second coil (72) is sealed with the second layer sealing resin (75), according to the need, a combination of the first coil (71) and the second coil (72) is added outside the second coil (72), in the first total shielding body (3) or the second total shielding body (47), the second shield (16) has a hemispherical structure, and the second shield core (23) has a hemispherical structure, the second shield core (23) is made of metal material, especially silicon steel sheet which are core punching materials, and a plurality of square grooves (70) are arranged on the outer surface of the second shield iron core (23) in sequence along the center direction, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need, a combination of the first coil (71) and the second coil (72) is added outside the second coil (72), in the first total shielding body (3) or the second total shielding body (47), the third shield (51) has a hemispherical structure, and the third shield core (50) has a hemispherical structure, the third shield core (50) is made of metal material, especially silicon steel sheet which are core punching materials, and a plurality of square grooves (70) are arranged on the outer surface of the third shield core (50) in sequence along the center direction, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), and a combination of multiple layers of the first coil (71) and the second coil (72) is added outside the second coil (72) according to the need.

4. The shield power generation system consists of coil, control circuit, capacitor and battery according to claim 1, characterized in that:
in the first total shielding body (3), the second conduit (53) is a non-metallic circular pipe, part of the second conduit (53) inside the second semi-circular stator core (50) is arranged as the 4th shield system (76), and the 4th shield (76) is in the shape of a ring, the part of the second conduit (53) outside the second semicircular stator core (50) is bent by 90 degrees, and the parts of the second conduit (53) and the 4th shield (76) inside the second semicircular stator core (50) are bent by 90 degrees, the 4th shield (76) is made of metal material, especially silicon steel sheet, which is a core punching material, a plurality of circumferential square grooves (70) is arranged on the outer surface of the 4th shield system (76) in sequence, and the first coil (71) is embedded in each square groove (70), the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need, a combination of the first coil (71) and the second coil (72) is added outside the second coil (72), in the first total shielding body (3) or the second total shielding body (47), the third conduit (56) is a nonmetallic circular tube, the fifth shield (77) is arranged at the part of (56) inside of the second semi-circular stator core (50) by the third conduit, and the fifth shield (77) is in a ring shape, the part of the third conduit (56) outside the second semicircular stator core (50) is bent by 90 degrees, and the parts of the third conduit (56) and the 5th shield (77) inside the second semicircular stator core (50) are bent by 90 degrees, on the outer surface of the 5th shield (77), a plurality of circumferential square grooves (70) are arranged in sequence, and the square grooves (70) of the 5th shield (77) are made of metal materials, especially silicon steel sheets, which is a core punching material, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need, a combination of the first coil (71) and the second coil (72) is added outside the second coil (72), in the first total shielding body (3) or the second total shielding body (47), the second vent pipe (58) is a nonmetallic circular pipe, a sixth shield (78) is arranged on the part of the second vent pipe (58) which enters the second semi-circular stator core (50), and the sixth shield (78) is annular, the part of the second vent pipe (58) outside the second semicircular stator core (50) is bent by 90 degrees, and the parts of the second vent pipe (58) and the sixth shield (78) inside the second semicircular stator core (50) are bent by 90 degrees, the square slots (70) of the sixth shield (78) are made of metal materials, especially silicon steel sheets which are core punching materials, a plurality of circumferential square slots (70) are arranged on the outer surface of the sixth shield (78) in sequence, and the first coil (71) is embedded in each square slot (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need, a combination of the first coil (71) and the second coil (72) is added outside the second coil (72), in the first total shielding body (3) or the second total shielding body (47), the first vent pipe (22) is a nonmetallic round pipe, the 7th shield (79) is arranged at the part of the first vent pipe (22) entering the first semicircular stator core (23), and the 7th shield (79) is in the shape of a ring, the first vent pipe (22) is bent by 90 degrees outside the first semi-circular stator core (23), and the first vent pipe (22) and the 7th shield (79) are bent by 90 degrees inside the first semi-circular stator core (23), on the outer surface of the 7th shield (79), a plurality of square grooves (70) are arranged in sequence along the circumferential direction, and the square grooves (70) of the 7th shield (79) are made of metal materials, especially silicon steel sheets, which are core punching materials, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), and a combination of multiple layers of the first coil (71) and the second coil (72) is added outside the second coil (72) according to the need.

5. The shield power generation system consists of coil, control circuit, capacitor and battery according to claim 1, characterized in that:
in the first total shielding body (3) or the second total shielding body (47), the output pipeline (48) of the motor fluid pump is a non-metallic circular pipe, the 8th shield (80) is arranged on the part where the motor fluid pump output pipeline (48) enters between the shell (9) and the outside of the core (10), the 8th shield (80) is in the shape of a ring, and the parts of the motor fluid pump output pipeline (48) and the 8th shield (80) outside the outside of the core (10) are bent by 90 degrees, on the outer surface of the 8th shield (80), a plurality of square grooves (70) are arranged in sequence along the circumferential direction, and the square grooves (70) of the 8th shield (80) are made of metal materials, especially silicon steel sheets, which are core punching materials, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need, a combination of the first coil (71) and the second coil (72) is added outside the second coil (72), in the first total shielding body (3) or the second total shielding body (47), the input pipe (14) of the fluid pump of the driving motor is a non-metallic circular pipe, the ninth shield (81) is arranged on the part where the drive motor fluid pump input pipeline (14) enters between the shell (9) and the outside of the iron core (10), the ninth shield (81) is in a ring shape, and the parts of the drive motor fluid pump input pipeline (14) and the ninth shield (81) outside the outside of the iron core (10) are bent by 90 degrees, on the outer surface of the ninth shield (81), a plurality of square grooves (70) are arranged in sequence along the circumferential direction, and the square grooves (70) of the ninth shield (81) are made of metal materials, especially silicon steel sheets, which are core punching materials, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), the second coil (72) is encapsulated with the second layer sealing resin (75), and a combination of multiple layers of the first coil (71) and the second coil (72) is added outside the second coil (72) according to the need.

6. The shield power generation system consists of coil, control circuit, capacitor and battery according to claim 1, characterized in that:
in the first total shielding body (3) or the second total shielding body (47), the first support (42) is fixed on the inner surface of the inner side (15) of the stator core by the first bolt (41), and the signal line and control line protector (38) are fixed on the first support (42), after entering the second conduit (53), the signal line (54) is connected with the first wire (46) of signal line and the control line protector (38) at the first connection point (52) of the signal line before entering the third shield core (50), the signal line, the second wire (32) of the control line protector (38) are connected with the signal line junction box (31) of the motor controller (6), which consists of the eleventh shield (135), in the first total shielding body (3) or the second total shielding body (47), the second support (44) is fixed on the inner surface of the inner side (15) of the stator core by the second bolt (45), the power surge protector (39) is fixed on the second support (44), after entering the third conduit (56), at the first connection point (55) of the power cord, the power cord (57) is connected in parallel with the first connection cable (43) of the second power surge protector before entering the housing (9), then, the power cord (57) enters the inside of the housing (9) and is connected with two DC input terminals (34) of the motor controller (6), and the protective ground wire (40) of the power surge protector (39) is connected with the inner surface of the inner side (15) of the stator core, which consists of the twelfth shield (136).

7. The shield power generation system consists of coil, control circuit, capacitor and battery according to claim 1, characterized in that:
in the first total shielding body (3) or the second total shielding body (47), the 10th shield (145) is in the shape of a disk, on the outer surface of the 10th shield (145), a plurality of square grooves (70) are arranged outwards along the center of the circle in sequence, and the square grooves (70) of the 10th shield (145) are made of metal materials, especially silicon steel sheets which are core punching materials, and the first coil (71) is embedded in each square groove (70); the second coil (72) is arranged at the upper part between every two adjacent first coils (71), and the second coil (72) and the first coil (71) form a shield; the first coil (71) is encapsulated with the first layer sealing resin (73), and the second coil (72) is encapsulated with the second layer sealing resin (75), according to the need a combination of multiple layers of the first coil (71) and the second coil (72) is added outside the second coil (72), the first coil (71) and the second coil (72) of the 10th shield (145) are arranged on the core (97), the core (97) is arranged on a fan (99) which is arranged on the first transmission shaft (93) of the motor (33), and the diameter of the fan (99) is larger than that of the transmission shaft channel (21), the diameter of the core (97) is larger than that of the transmission shaft channel (21), the diameter of the 10th shield (145) is larger than that of the transmission shaft channel (21), and a plurality of circumferential square grooves (70) are arranged on the outer surface of the core (97) in sequence, the first coil (71) is embedded in each slot, and the second coil (72) is arranged in the upper part between two adjacent first coils (71), and the second coil (72) and the first coil (71) form a shield, the first coil (71) is encapsulated with the first layer sealing resin (73), and the second coil (72) is encapsulated with the second layer sealing resin (75), and the first coil (71) and the second coil (72) windings are enameled wire windings, multiple layers of the second coil (72) can be added to the outside of the first coil (71), and the 10th shield (145) connected above prevents the electromagnetic field generated by the motor controller (2) and the motor (33) from leaking out of the outer shield (9) through the gap of the transmission shaft channel (21) after the motor (33) is energized.

8. The shield power generation system consists of coil, control circuit, capacitor and battery according to claim 1, characterized in that:
the transmission shaft (20) consists of the first transmission shaft (93) and the second transmission shaft (98), the second transmission shaft (98) is a metal body, and the first transmission shaft (93) is made of non-magnetic material, the first transmission shaft (93) and the second transmission shaft (98) are connected at the third connection point (96), and the third connection point (96) cannot enter the core (97), the 4th connecting line (92) connects with the first coil (71) and the second coil (72) passing through the first transmission shaft (93) and the second transmission shaft (98), and is connected with the first bearing (26) at the first bearing connection point (101) which is on the first bearing inner ring (102); the non-conductive and non-magnetically conductive first insulator (107) is arranged between the first bearing inner ring (102) and the second transmission shaft (98), and the non-conductive and non-magnetically conductive second insulator (105) is arranged outside the first bearing outer cover (106), the first connecting line (100) of the motor is connected with the first bearing cover (106), the external first connecting line (100) of the motor is connected with the second shield (16) through the first line outlet (125) of the 7th shield (79) of the first vent pipe (22), the first bearing (26) consists of a bearing inner ring (102), a bearing bead of the first bearing (103), the first bearing protrusion (104) defining the inner ring and the first bearing outer cover (106), the second super bearing (30) includes the third bearing (112) and the 4th bearing (118), the 5th connecting line (94) connects with the first coil (71) and the second coil (72) passing through the first transmission shaft (93) and the second transmission shaft (98) is connected with the third bearing (112) at the third bearing connection point (110) on the third bearing inner ring (109), a non-conductive and non-magnetic third isolator (115) is arranged between the third bearing inner ring (109) and the second transmission shaft (98), the 4th insulator (113) which is non-conductive and non-conductive is arranged on the outside of the third bearing outer cover (108), and the external connection line (124) of the motor is connected with the third bearing outer cover (108), the external connection line (124) of the motor is connected with the second shield (16) through the first line outlet (125) of the 7th shield (79) of the first vent pipe (22), the third bearing consists of the third bearing inner ring (109), the third bearing bead (111), the third bearing protrusion (114) defining the inner ring and the third bearing outer cover (108), the sixth connecting line (95) connects with the first coil (71) and the second coil (72) and passes through the first transmission shaft (93) and the second transmission shaft (98), and the 4th bearing (118) is connected at the 4th bearing connection point (116) which is on the 4th bearing inner ring (121), the non-conductive and non-magnetic 5th insulator (120) is arranged between the 4th bearing inner ring (121) and the second transmission shaft (98), and the non-conductive and non-magnetic sixth insulator (119) is arranged outside the 4th bearing outer cover (117), the external motor the third connecting line (123) is connected with the third bearing outer cover (117), the external connection line (123) of the motor is connected with the second shield (16) through the first line outlet (125) of the 7th shield (79) of the first vent pipe (22), the 4th bearing (118) consists of the 4th bearing inner ring (121), the bearing bead of the 4th bearing (126), the 4th bearing bulge (122) defining the inner ring and the bearing outer cover of the 4th bearing (117).

9. The shield power generation system consists of coil, control circuit, capacitor and battery according to claim 1, characterized in that:
a motor controller (2) and a motor (33) are arranged in the first total shielding body (3), and the motor controller (2) is fixedly connected to the radial periphery of the motor (33), the motor controller (2) outputs three-phase power to the motor (33), and then drives the motor (33) to rotate, the motor (33) includes a motor stator core (29) and a stator coil (36), and a motor rotor (28) is arranged in the motor (33), and the rotor coil (25) is fixed on the motor rotor (28), the motor spindle (20) is connected with the motor rotor (28), the first bearing (26) is arranged on the front-end cover (24), and the second super bearing (30) is arranged on the rear end cover (35), the motor spindle (20) passes through the first bearing (26) and the second super bearing (30), and the second super bearing (30) includes the third bearing (112) and the 4th bearing (118), the first support (42) is fixed on the inner surface of the inner side (15) of the stator core by the first bolt (41), and the signal line and control line protector (38) are fixed on the first support (42), after the signal line (54) enters the second conduit (53), it is connected to the first conducting wire of the signal line and the control line protector at the first connection point (52) (38) before entering the shielding system (8), the second wire (32) of the signal line and control line protector (38) is connected with the signal line junction box (31) of the motor controller (6), and the protective ground wire (37) of the signal line and control line protector (38) is connected with the inner surface of the stator core (15), by connecting the inner surface of the inner core (15), the absorbed energy is channeled to the inner core (15), the second support (44) is fixed on the inner surface of the inner side (15) of the stator core by the second bolt (45), and the power surge protector (39) is fixed on the second support (44), after entering the third conduit (56), the power cord (57) is connected in parallel with the first connection line (43) of the second power surge protector at the first connection point (55) of the power cord before entering the housing (9), then, the power cord (57) enters the inside of the casing (9) and is connected with two DC input terminals (34) of the motor controller (6), and the protective ground wire (40) of the power surge protector (39) is connected with the inner surface of the stator core inner side (15) to channel the absorbed energy to the stator core inner side (15), the drive motor fluid pump (64) has a drive motor fluid pump output pipeline (48) and a drive motor fluid pump input pipeline (14), the drive motor cooling system (61) includes a fluid circulation pipeline, and the drive motor fluid pump electronics (66) guide the drive motor fluid pump (64) to pump fluid from the fluid storage (65) into the fluid supply fluid receiving end coolant channel (11), the fluid is recycled to the drive motor fluid pump (64) via the drive motor fluid pump output pipeline (48), the first conduit (18) passes through the semi-circular shell (17) outside the first hemispherical stator core (23) and is fixed on the semi-circular shell (17), a connecting line (19) of the first total shielding body (3) passes through the first conduit (18) and is connected with the backup battery (6) through the electronic control system (4).

10. The shield power generation system consists of coil, control circuit, capacitor and battery according to claim 1, characterized in that:
a motor (33) is arranged in the second total housing body (47), and the motor (33) includes a motor stator core (29) and a stator coil (36), the motor (33) is internally arranged with a motor rotor (28), the rotor coil (25) is fixed on the motor rotor (28), the motor spindle (20) is connected with the motor rotor (28), the first bearing (26) is arranged on the front-end cover (24), and the second bearing (30) is arranged on the rear end cover (35), the motor spindle (20) passes through the first bearing (26) and the second super bearing (30), and the second super bearing (30) includes the third bearing (112) and the 4th bearing (118), the second support (44) is fixed on the inner surface of the inner side (15) of the stator core by the second bolt (45), and the power surge protector (39) is fixed on the second support (44), after entering the third conduit (56), the power cord (57) is connected in parallel with the first connection cable (43) of the second power surge protector at the first connection point (55) of the power cord before entering the housing (9), then, the power cord (57) enters the inside of the casing (9) and is connected with two DC input terminals (34) of the motor controller (6), and the protective ground wire (40) of the power surge protector (39) is connected with the inner surface of the stator core inner side (15) to channel the absorbed energy to the stator core inner side (15), the drive motor fluid pump (64) has a drive motor fluid pump output pipeline (48) and a drive motor fluid pump input pipeline (14), the drive motor cooling system (61) includes a fluid circulation pipeline, and the drive motor fluid pump electronics (66) guide the drive motor fluid pump (64) to pump fluid from the fluid storage (65) into the fluid supply fluid receiving end coolant channel (11), the fluid is recycled to the drive motor fluid pump (64) via the drive motor fluid pump output pipeline (48), the first conduit (18) passes through the semi-circular shell (17) outside the first hemispherical stator core (23) and is fixed on the semi-circular shell (17), a connecting line (19) of the total shielding body (3) passes through the first conduit (18) and is connected with the backup battery (6) through the electronic control system (4).

11. The shield power generation system consists of coil, control circuit, capacitor and battery according to claim 1, characterized in that:
a motor (33) is arranged in the second total shielding body (47), and the motor (33) includes a motor stator core (29) and a stator coil (36), the motor (33) is internally arranged with a motor rotor (28), the rotor coil (25) is fixed on the motor rotor (28), the motor spindle (20) is connected with the motor rotor (28), the first bearing (26) is arranged on the front-end cover (24), and the second bearing (30) is arranged on the rear end cover (35), the motor spindle (20) passes through the first bearing (26) and the second super bearing (30), and the second super bearing (30) includes the third bearing (112) and the 4th bearing (118), after the power cord (57) enters the third conduit (56), the power cord (57) enters the inside of the housing (9) and is connected with two DC input terminals (34) of the motor controller (6), the driving motor fluid pump (64) has a driving motor fluid pump output pipeline (48) and a driving motor fluid pump input pipeline (14), the drive motor cooling system (61) includes a fluid circulation pipeline, and the drive motor fluid pump electronics (66) guides the drive motor fluid pump (64) to pump fluid from the fluid storage (65) into the fluid supply fluid receiving end coolant channel (11), and the fluid is recycled into the drive motor fluid pump (64) via the drive motor fluid pump output pipeline (48), the first conduit (18) passes through the semi-circular shell (17) outside the first hemispherical stator core (23) and is fixed on the semi-circular shell (17), and the connecting wire (19) of the total shielding body (3) passes through the first conduit (18) and is connected with the backup battery (6) through the electronic control system (4).

12. The shield power generation system consists of coil, control circuit, capacitor and battery according to claim 1, characterized in that:
the first driving motor (67) of electric vehicle (7) is matched with the first gear box (86), and the second driving motor (68) is matched with the second gear box (87), the backup battery (6) supplies power to the main battery (1), which supplies power to the electronic devices (69) of the electric vehicle (7) and drives the first drive motor (67) and the second drive motor (68) to push the electric vehicle (7) to move, the motor housing (9) is arranged on the third bracket (141), the third screw (142) and the 4th screw (143) are used to fix the third bracket (141) on the electric vehicle (7), the motor housing (9) conducts the energy from the grounding wire of the first total shielding body (3) or the second total shielding body (47) inside the motor housing (9) to the body of the electric vehicle (7) by connecting the third bracket (141), which is made of conductive metal material.
